(19) United States
(12) Patent Application Publication
(10) Pub. No.: US 2005/0185512 A1
(43) Pub. Date: Aug. 25, 2005

(54) Paintball goggle system audio game timer

(76) Inventors: David J. DeHaan, Encinitas, CA (US); Bryon E. Benini, San Marcos, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/104,903

(22) Filed: Apr. 12, 2005

Related U.S. Application Data
(63) Continuation-in-part of application No. 10/242,906, filed on Sep. 13, 2002, now Pat. No. 6,886,183.

(51) Int. Cl. G04F 8/00

(52) U.S. Cl. 368/3

(57) ABSTRACT

The present invention is directed to a unique small electronic audio timing device that attaches within a goggle system, helmet, or any other face or head-covering unit. The device is mounted adjacent to one or both ears and is to be activated at the beginning of a game or event. At set intervals throughout the game or event the device gives an audio indication of the remaining time of the game or event. The audio is generated by means of an integrated circuit voice synthesizer within the device. The device also contains a liquid crystal display that provides a visual image for initially setting the time sequence, which is activated though the pressing of a start/stop button and a timer set button.

This application is a continuation-in-part of co-pending U.S. Non-provisional patent application Ser. No. 10/242,906 filed on Sep. 13, 2002.

### FIELD OF THE INVENTION

This invention relates to the field of electronic audio timers. More specifically, this patent deals with a unique electronic audio timing device that attaches within a goggle system, helmet, or any other face or head-covering device. Timers are commonly used to establish the length of games and events and to announce the conclusion of the activity. Most timers use visual or alarm systems designed to only announce the conclusion. With the advent of compact electronics and the integrated circuit voice synthesizers, a unique method has been devised by the inventor to generate the count down for the remaining time of a game or event. The device mounts adjacent to one or both ears and is to be set at the beginning of a game or event. At specific intervals throughout the game or event, the timer gives the remaining time to the contestant. The device has been designed for, but is not limited to, the game of paintball.

### BACKGROUND OF THE INVENTION

Initially, pneumatic paintball markers were used to mark trees and inaccessible objects for removal or identification. The use of the markers have further developed into the sport known as “Paintball” in which the spherical projectiles containing colored liquid are fired at an opponent and burst upon contact so that the colored liquid is deposited on the opponent, scoring a hit by the combatant. All of the participants involved in the sport are required to wear an abundance of protective gear, including some form of face and ear protection, so that the paint balls do not hit a vital part of the participant's anatomy. The state of the art protection for the head is a new paintball goggle system that covers the entire face and sides of the head, including the ears. This system is held on by an elastic strap behind the head with another strap under the chin. Paintball games are most often played in a confined area for a designated time. The time limit for each paintball game is kept by the officials, with an alarm bell sounding at the conclusion of the game. While the game is being played, the users typically do not know the elapsed time or the proximity to the conclusion of the game. A variety of visual devices that have been developed to notify the users of the time limits of the game are herein disclosed.

U.S. Pat. No. 6,615,814 B1 of John Ronald Rice et al. describes an invention that provides a paintball gun, including a data link for transferring data to and/or from a remote terminal. According to the present invention there is further provided electronic apparatus, comprising a paintball gun, a terminal and means for transferring data and/or communicating between the gun and terminal. A display panel may be mounted on the gun or may alternatively (or additionally) be situated remotely from the gun. For example, the display panel can be a display on a remote terminal such as a computer terminal, a personal digital assistant (PDA), a telephone, or many other devices, such as components attached to the gun. Data may be transferred to the panel by a direct (wired) link. Examples include a serial link or USB link. Data may also be transferred to the panel by a contact-less method such as by infrared communication, radio links (digital or analog), microwave links, or even by telephone cable internet, etc.

This patent describes a variety of electronics to control and disperse information that may include the timing of paintball games. However, the indicated device relies on some form of visual display system in which the opponents must take their eyes off the target to see and interpret the information, and cannot be used for other games or events.

U.S. Pat. No. 6,311,682 B1 of John Ronald Rice et al. describes an electronically controlled pneumatic paintball gun, comprising monitoring and/or controlling apparatus for monitoring and/or controlling one or more parameters of the gun's operation, and alphanumeric means for displaying data related to said monitoring or control on a display panel integral with the gun. The display panel is most preferably mounted on the cheek of the gun.

This patent describes another electronic device with a display panel integrated with the paintball gun (preferably called a paintball marker), in which the opponents must take their eyes off the targets to see and interpret the information.

U.S. Pat. No. 6,062,208 of William J. Seefieldt et al. is directed to improvements for a pressure gun that is utilized to propel paint containing balls which will, when they strike, break and apply paint to a target or, as utilized in the sport of Paint or Splat Ball, an opposing user, to identify such person as having been hit and therefore out of the game. The improvements include both a retro-fit and a custom adapted monitor with visual readout for counting the number of balls which have been shot by sensing pressure drop, or through Hall effect sensing, or mechanical switch actuation, the latter two sensing propelling bolt movement. The monitor also includes a visual readout for reverse-timing to show the user's game time remaining, and a tank pressure supply readout, which shows the user remaining tank pressure. Through micro processing of the information of shot count and time remaining or time elapsed, a shooting rate is determinable. Both the retrofit unit and the custom unit supply the same basic information to the microprocessor, which then calculates shot rate.

This patent describes a still another electronic device with a monitor and visual readout integrated with the paintball marker, in which the opponents must take their eyes off the targets to see and interpret the information.

U.S. Pat. No. 5,736,720 of Roderick L. Bell et al. describes a paintball game scorekeeper and an associated paintball game playing system. The paintball game scorekeeper includes a switch member having plural control buttons insertably mounted in a recess formed in a front side surface of a housing. A printed circuit board to which the control buttons are electrically connected is inserted in a recess formed in a rear side surface of the housing. The printed circuit board comprises a memory subsystem for holding a countdown time and at least one interim time, a processor subsystem for counting down, from the countdown time, time remaining in the on-going game of paintball until time expires and for determining first and second elimination counts, and an LCD display, electrically coupled to the processor subsystem for displaying the time remaining in the on-going game of paintball, the first elimination count and the second elimination count. By selectively depressing the control buttons, the processor subsystem will start and stop the count down of time remaining, record the time remaining in the memory subsystem as a flag time and increment or decrement the first and second elimination counts. By mounting the paintball game scorekeeper on a rear side surface of a bulk loader for holding paintballs, the paintball game scorekeeper forms part of a paintball game playing system which includes a paintball gun and the bulk loader and may be readily used by a participant in the on-going game of paintball without significantly disrupting the participant's ability to play.

This patent describes yet another electronic device with a LCD display integral with the paintball marker where the opponents must take their eyes off the targets to see countdown time remaining in the on-going game of paintball. Additionally, this timer is affixed to a paintball marker and cannot be effectively used in many other timed games and events.

U.S. Pat. No. 4,326,710 of Jeffery D. Breslow et al. describes a talking electronic game that utilizes an integrated circuit voice synthesizer to generate a plurality of beginning phrases each forming the beginning of a complete phrase and a plurality of ending phrases each forming the end of the complete phrase. The beginning and ending phrases are assigned at random to a plurality of push buttons, and the object of the game is to match up the beginning and ending phrases of the various sentences by appropriate actuation of the various push buttons.

Although this patent describes a talking electronic game that utilizes an integrated circuit voice synthesizer to generate a plurality of beginning phrases, it has not been designed as a game countdown timer to be installed within the helmet, headgear, or any other face or head covering of the game participants.

None of the foregoing prior art teaches or suggests the particular unique features of the paintball goggle system audio game timer and could not be used as a timer for other games or events, thus this clarifies the need for further improvements in timers, especially those used in sport of paintball.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle object of the paintball goggle system audio game timer is to create an audio electronic game timer with an integrated circuit voice synthesizer to give the user an audio countdown of the remaining time of a game or event.

Another object of this invention is to create an audio electronic game timer that fits into a goggle system, helmet, or any other face or head-covering device, and is substantially adjacent to one or both ears.

Another object of this invention is to create a game timer that the users are not required to look at, allowing them to look at and concentrate on their intended targets or activity.

Another object of this invention is to create an audio electronic game timer that is not encumbering when worn adjacent to one or both ears.

Another object of this invention is to create an audio electronic game timer that can be heard by a participant in a highly-active and noisy game or event.

And still another object of this invention is to create an audio electronic timer that can easily be reached, to start or reset the remaining time.

A further object is to create a timer that will stand a great deal of abuse while being worn by participants in strenuous activities.

A final object of this invention is to add a new and unique device to the field of timers to enhance a variety of sporting games and events.

The preferred embodiment of the paintball goggle system audio game timer will be a small compact device that will lock in place within a goggle system, helmet, or any other face or head-covering unit, adjacent to one or both ears. The device will have a front surface that contains the timer display screen, the start/stop button, the timer set button, the battery cavity cover, the micro speaker orifices, the retainer tabs, and the installation-locking tab. The audio will be created by the means of an integrated circuit voice synthesizer generating the countdown for the remaining time of a game or event. The internal components housed in the lower half of the device container consist of internal retainers for securing the micro speaker, the batteries, and the printed circuit board with the liquid crystal display (LCD) unit mounted on the upper surface. The start/stop button protrudes through an orifice in the side of the lower half of the device container. The micro switch is adjacent to the start/stop button and held in place by additional retainers. The batteries are inserted within the battery cavity orifice with one battery in the up position and the other battery in the down position.

The alternate embodiment of the device will have the same basic shape and the same internal components, but with different mounting tabs to accommodate different styles of headgear.

The game timer begins with the display screen reading “00:00” as soon as the batteries have been installed. The timer set button is then pressed once to enter adjustment mode. Pressing the timer set button again will increase the minute and second increments. Timer will adjust to set minute increments of 1 minute to 60 minutes. The voice alert will sound off the minutes as the timer set button is pressed to adjust the time. The timer will also adjust to set second increments of 1 second to 60 seconds. The voice alert will sound off the seconds as the start/stop button is pressed to adjust the time. Switching from minute to second adjustment is accomplished by pressing and holding the timer set button and then pressing the start/stop button for a full second. Pressing the start/stop button once will initiate countdown. The timer will beep and announce the currently set game time. Pressing the start/stop button again will pause the timer. Pressing and holding the start/stop button will reset the countdown. The game timer will automatically shutoff after 10 minutes of inactivity in order to conserve battery power.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

These, together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a perspective view of the preferred embodiment of the paintball goggle system audio game timer.

FIG. 2 depicts an exploded perspective view of the paintball goggle system audio game timer illustrating the internal components.

FIG. 3 depicts a perspective view of one style of paintball goggle headgear illustrating the location for mounting the paintball goggle system audio game timer.

FIG. 4 depicts the paintball goggle system audio game timer and timer inserted within the paintball goggle headgear.

FIG. 5 depicts a perspective view of an alternate embodiment of the paintball goggle system audio game timer.

FIG. 6 depicts a perspective view of a different style of paintball headgear illustrating the location for mounting the alternate embodiment of the paintball goggle system audio game timer.

FIG. 7 depicts the alternate embodiment of the paintball goggle system audio game timer and timer inserted within the different style of paintball goggle headgear.

FIG. 8 depicts an electrical schematic of the preferred and alternate embodiment of the paintball goggle system audio game timer.

### DETAILED DESCRIPTION OF THE PREFERRED EMBODIMENTS

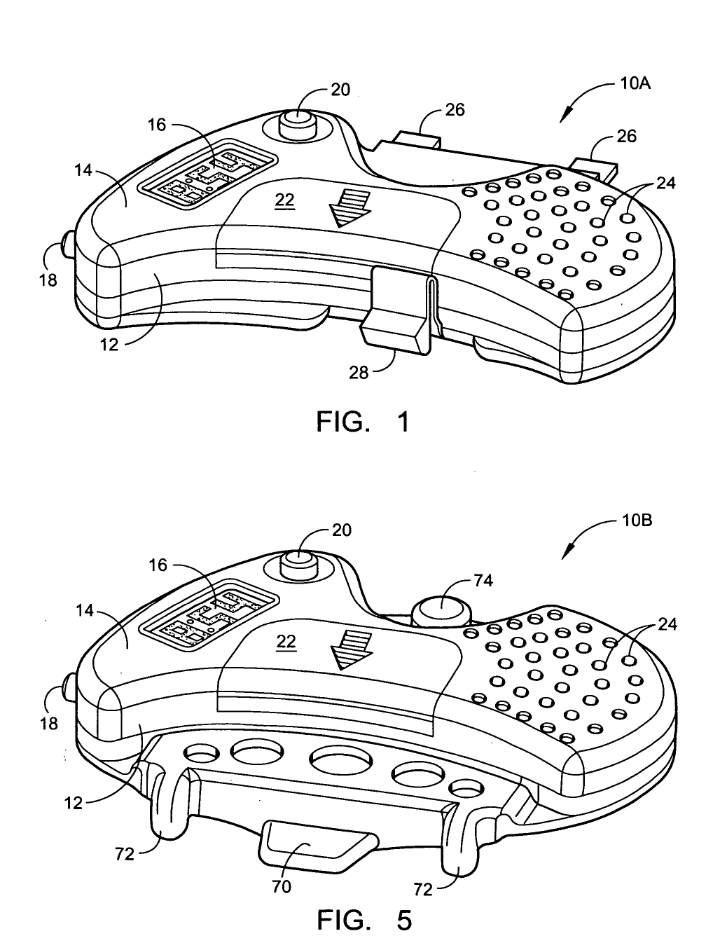

Referring now to the drawings, wherein similar parts are identified by like reference numerals, there is seen in FIG. 1 a perspective view of the preferred embodiment of the paintball goggle system audio game timer 10A illustrating the external surface 12. The front surface 14 contains the timer display screen 16, the start/stop button 18, the timer set button 20, the battery cavity cover 22, the micro speaker orifices 24, the retainer tabs 26, and the installation-locking tab 28.

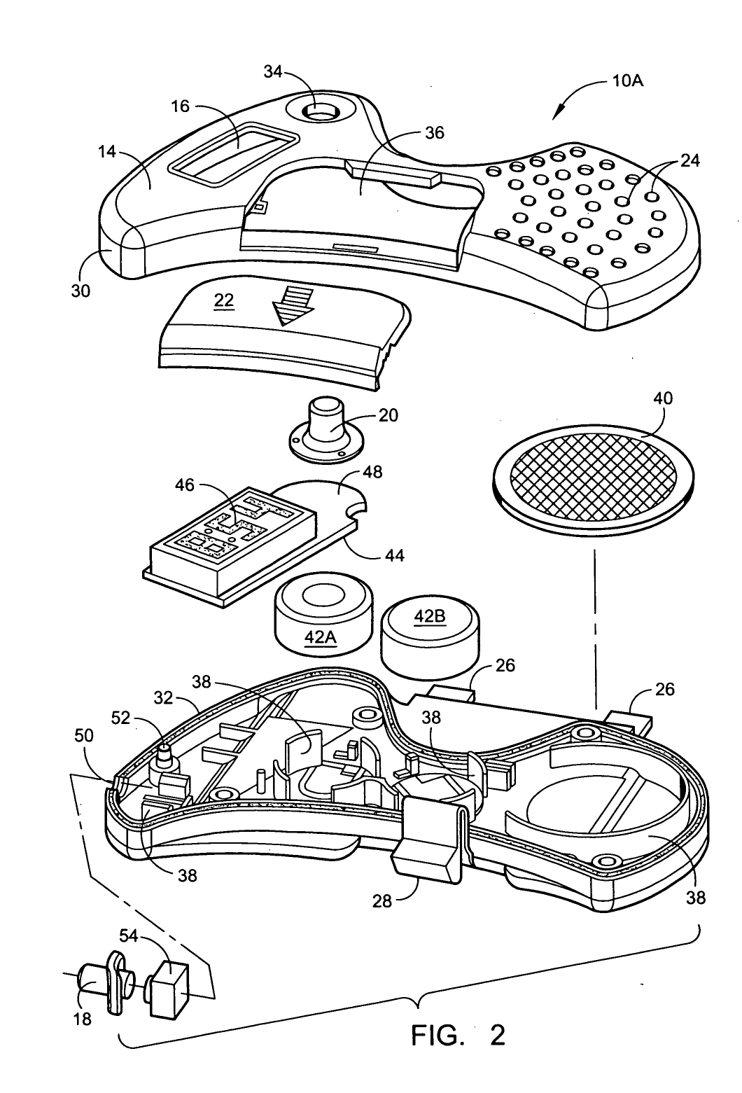

FIG. 2 depicts an exploded perspective view of the paintball goggle system audio game timer 10A illustrating the upper half 30 and the lower half 32 of the device container housing the internal components. The upper half 30 having the front surface 14 with the timer display screen 16, the timer set button orifice 34, the battery cavity orifice 36, and the micro speaker orifices 24. The lower half 32 having a variety of internal retainers 38 for securing the micro speaker 40, the batteries 42A and 42B, and the printed circuit board 44 with the liquid crystal display (LCD) unit 46 mounted on the upper surface 48. The start/stop button 18 protrudes through an orifice 50 in the side 52 of the lower half 32 of the container. The micro switch 54 is adjacent to the start/stop button 18 and held in place by additional retainers 38. The batteries 42A and 42B are inserted within the battery cavity orifice 36, with battery 42A in the up position and battery 42B in the down position, and are covered by the battery cavity cover 22.

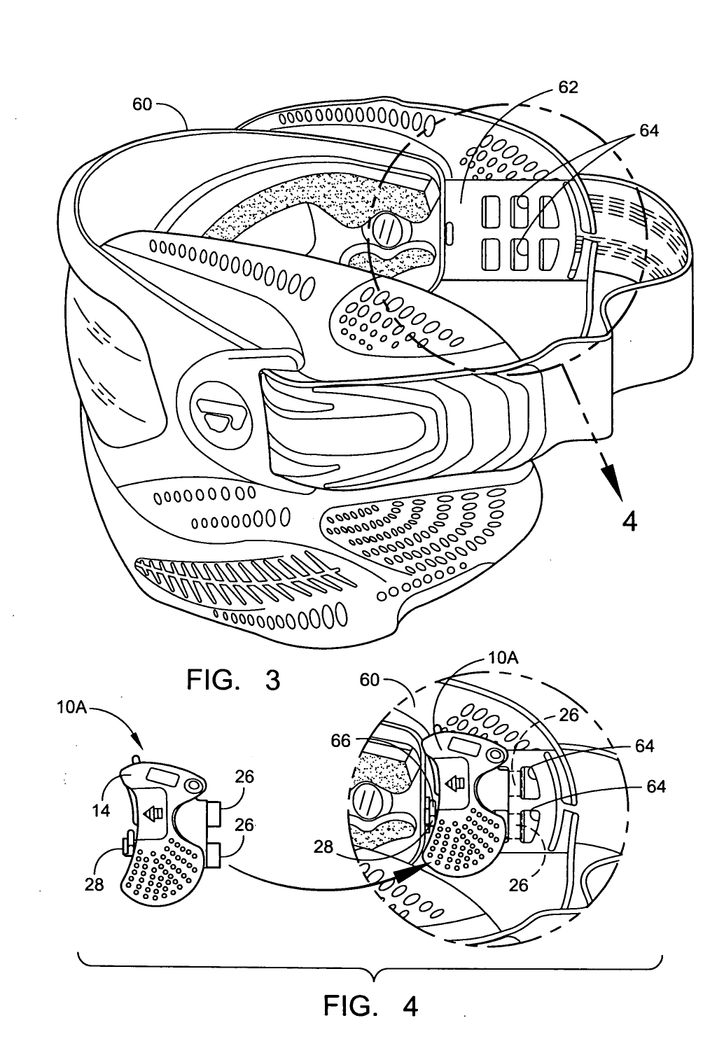

FIG. 3 depicts a perspective view of one style of paintball goggle headgear 60 illustrating the mounting location 62 for the paintball goggle system audio game timer 10A, with the retaining orifices 64 for the retainer tabs 26 and the locking orifice 66 for the installation-locking tab 28. The installation of the paintball goggle system audio game timer 10A within the one style of paintball goggle headgear 60 is further clarified in FIG. 4. In this view, the paintball goggle system audio game timer 10A is shown apart from and also installed in the mounted position with retainer tabs 26 within the retaining orifices 64 and the installation-locking tab 28 in the locking orifice 66.

FIG. 5 depicts a perspective view of an alternate embodiment of the paintball goggle system audio game timer 10B illustrating a similar external surface 12. Front surface 14 contains the timer display screen 16, the start/stop button 18, the timer set button 20, the battery cavity cover 22, the micro speaker orifices 24, but uses a single locator tab 70, two retainers 72, and a locking button 74 for mounting the alternate embodiment of the paintball goggle system audio game timer 10B into place.

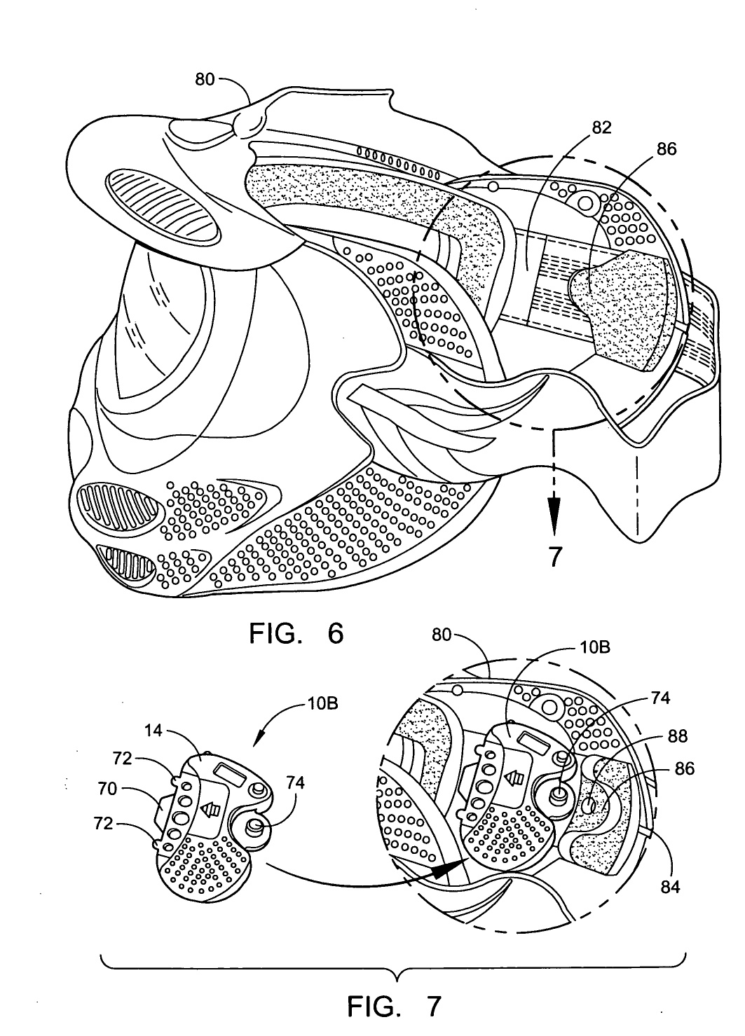

FIG. 6 depicts a perspective view of a different style of paintball headgear 80 illustrating the mounting location 82 for the alternate embodiment of the paintball goggle system audio game timer 10B. The installation of the alternate embodiment of the paintball goggle system audio game timer 10B within a different style of paintball goggle headgear 80 is further clarified in FIG. 7. In this view the alternate embodiment of the paintball goggle system audio game timer 10B is shown apart from and also installed in the mounted position, with head strap 84 having the foam padding 86 turned back from locking button 74 to reveal the locking orifice 88.

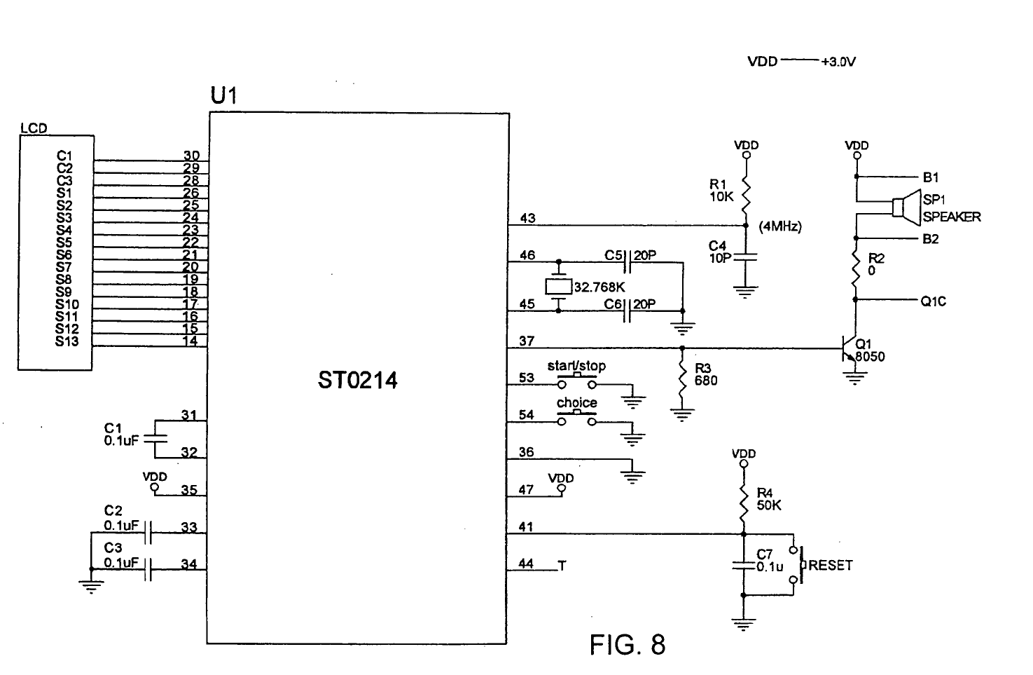

FIG. 8 depicts an electrical schematic of the preferred and alternate embodiment of the paintball goggle system audio game timer 10A and 10B.

The paintball goggle system audio game timer 10A and 10B shown in the drawings and described in detail herein disclose arrangements of elements of particular construction and configuration for illustrating preferred and alternate embodiments of structure and method of operation of the present invention. It is to be understood however, that elements of different construction and configuration and other arrangements thereof, other than those illustrated and described, may be employed for providing a paintball goggle system audio game timer 10A and 10B in accordance with the spirit of this invention, and such changes, alternations and modifications as would occur to those skilled in the art, are considered to be within the scope of this invention as broadly defined in the appended claims.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

1. A method of using one or more audio game timers for informing a user of the time remaining in a game or event comprising the steps of:
a) providing one or more audio game timers including a speaker and electronics for the purpose of counting down the time remaining in a game or event from a preset amount of time and audibly emitting the time remaining in a game or event at specific points in time;
b) setting the time remaining in a game or event;
c) locating said one or more audio game timers substantially adjacent to one or both ears of said user; and
d) initiating a countdown of the time remaining in a game or event.
whereby at specific points in time said electronics cause said one or more audio game timers to audibly emit the time remaining in a game or event to inform the user of the time remaining in a game or event.

2. The method of using one or more audio game timers for informing a user of the time remaining in a game or event according to claim 1, wherein said step of setting the time remaining in a game or event includes the steps of:
a) pressing a timer set button to enter the timer minute adjustment mode; and
b) pressing said timer set button one or more times to increment the timer minutes to the time limit minutes for a game or event.

3. The method of using one or more audio game timers for informing a user of the time remaining in a game or event according to claim 1, wherein said step of locating said one or more audio game timers substantially adjacent to one or both ears of a user includes the steps of:
a) providing a means for locating said one or more audio game timers substantially adjacent to one or both ears of a user;
b) removably attaching said one or more audio game timers to said means for locating said one or more audio game timers substantially adjacent to one or both ears of the user; and
c) positioning said means for locating said one or more audio game timers substantially adjacent to one or both ears of a user so said one or more audio game timers is substantially adjacent to one or both ears of the user.

4. The method of using one or more audio game timers for informing a user of the time remaining in a game or event according to claim 1, wherein said step of initiating a countdown of the time remaining in a game or event includes the step of pressing a start/stop button.

5. The method of using one or more audio game timers for informing a user of the time remaining in a game or event according to claim 2, further comprising the steps of:
a) pressing and holding said timer set button and pressing and holding a start/stop button for a specified period of time to enter the timer second adjustment mode; and
b) pressing said timer set button one or more times to increment the timer seconds to the time limit seconds for a game or event.

6. A method of using one or more audio game timers for informing a user of the time remaining in a game of paintball comprising the steps of:
a) providing one or more audio game timers including a speaker and electronics for the purpose of counting down the time remaining in a game of paintball from a preset amount of time and audibly emitting the time remaining in a game of paintball at specific points in time;
b) setting the time remaining in a game of paintball;
c) locating said one or more audio game timers substantially adjacent to one or both ears of said user; and
d) initiating a countdown of the time remaining in a game or event.
whereby at specific points in time said electronics cause said one or more audio game timers to audibly emit the time remaining in a game of paintball to inform the user of the time remaining in a game of paintball.

7. An audio game timer that can be removably integrated into a goggle protection system, helmet, or any other face or head covering device comprising:
a) a housing, said housing having a battery compartment and a plurality of speaker orifices;
b) a speaker, a visual display, and a start/stop button located within said housing;
c) a printed circuit board positioned within said housing for the purpose of controlling said speaker, said visual display, and said start/stop button; and
d) means for adjusting said visual display located within said housing
whereby at specific points in time said audio game timer counts down and audibly emits the time remaining in a game or event to inform a user of the time remaining in a game or event.

8. The audio game timer that can be removably integrated into a goggle protection system, helmet, or any other face or head covering device of claim 7, wherein said housing contains an installation-locking tab located on one side and one or more retainer tabs located on the other side
whereby to removably integrate said audio game timer into said goggle protection system, helmet, or any other face or head covering device a user inserts said one or more retainer tabs into the appropriate slots in said goggle protection system, helmet, or any other face and head covering device and presses said installation-locking tab downward until it locks into position.

9. The audio game timer that can be removably integrated into a goggle protection system, helmet, or any other face or head covering device of claim 7, wherein said housing contains at least two retainer tabs located on one side, a locator tab positioned between said at least two retainer tabs, and a locking button located on the other side
whereby to removably integrate said audio game timer into said goggle protection system, helmet, or any other face or head covering device a user inserts said locator tab and said at least two retainer tabs into the appropriate slots in said goggle protection system, helmet, or any other face or head covering device and presses said locking button downward until it locks into position.

10. The audio game timer that can be removably integrated into a goggle protection system, helmet, or any other face or head covering device of claim 7, wherein said start/stop button is positioned substantially adjacent to a micro-controller.

11. The audio game timer that can be removably integrated into a goggle protection system, helmet, or any other face or head covering device of claim 7, wherein said means for adjusting said visual display comprises one or more buttons.

12. The audio game timer that can be removably integrated into a goggle protection system, helmet, or any other face or head covering device of claim 7, wherein said speaker audibly emits the time remaining in a game or event at specific points in time.

13. The audio game timer that can be removably integrated into a goggle protection system, helmet, or any other face or head covering device of claim 7, wherein said visual display is mounted on said printed circuit board.

14. The audio game timer that can be removably integrated into a goggle protection system, helmet, or any other face or head covering device of claim 7, wherein said visual display is a liquid crystal display.

15. The audio game timer that can be removably integrated into a goggle protection system, helmet, or any other face or head covering device of claim 7, wherein said audio game timer will power off after a period of inactivity to conserve power.

16. The audio game timer that can be removably integrated into a goggle protection system, helmet, or any other face or head covering device of claim 7, wherein said start/stop button can be used to pause and reset the countdown of the time remaining in a game or event.

17. The audio game timer that can be removably integrated into a goggle protection system, helmet, or any other face or head covering device of claim 7, wherein the audible emission of the time remaining in a game or event is generated by an integrated circuit voice synthesizer.

18. The audio game timer that can be removably integrated into a goggle protection system, helmet, or any other face or head covering device of claim 7, wherein said housing is comprised of a durable material for the purpose of being able to withstand a substantial amount of abuse.

19. The audio game timer that can be removably integrated into a goggle protection system, helmet, or any other face or head covering device of claim 12, wherein said speaker audibly emits the time remaining in a game or event at the 60, 50, 40, 30, 20, 10, 5, 4, 3, 2, and 1 minute points and at the 50, 40, 30, 20, 10, 9, 8, 7, 6, 5, 4, 3, 2, and 1 second points.

20. The audio game timer that can be removably integrated into a goggle protection system, helmet, or any other face or head covering device of claim 19, wherein said speaker audibly emits a message indicating the end of a game or event after the expiration of the 1 second point.
